(19) United States
(12) Patent Application Publication
(10) Pub. No.: US 2008/0241693 A1
(43) Pub. Date: Oct. 2, 2008

(54) Lithium transition metal complex oxide for lithium ion secondary battery cathode active material and method for producing the same, lithium ion secondary battery cathode active material, and lithium ion secondary battery

(76) Inventors: Minoru Fukuchi, Tokyo (JP); Fumihiro Yonekawa, Tokyo (JP)

Correspondence Address: SMITH PATENT OFFICE, 1901 PENNSYLVANIA AVENUE N W, SUITE 901, WASHINGTON, DC, 20006, US

(21) Appl. No.: 12/076,242

(22) Filed: Mar. 14, 2008

(30) Foreign Application Priority Data
Mar. 30, 2007 (JP) 2007-094190
Mar. 10, 2008 (JP) 2008-059244

(51) Int. Cl. H01M 4/48

(52) U.S. Cl. 429/231.1; 252/182.1

(57) ABSTRACT

A lithium transition metal complex oxide for a lithium ion secondary battery cathode active material contains 100 to 1000 ppm of silicon and 300 to 900 ppm of fluorine. A method for producing the lithium transition metal complex oxide includes the step of mixing a lithium compound, a transition metal compound, a fluorine compound, and a silicon compound to prepare a raw material mixture, and the step of firing the raw material mixture to produce the lithium transition metal complex oxide.

### BACKGROUND OF THE INVENTION

1. Field of the Invention

The present invention relates to a lithium ion secondary battery exhibiting superior cycling characteristics, a lithium transition metal complex oxide for a lithium ion secondary battery cathode active material and the lithium ion secondary battery cathode active material that are used in the manufacture of the lithium ion secondary battery, and a method for producing the lithium transition metal complex oxide.

2. Description of the Related Art

As portable or cordless household appliances are rapidly becoming widespread, lithium ion secondary batteries are brought into practical use as power sources for miniature-size electronic equipment, such as laptop personal computers, cellular phones, and video cameras. Since Mizushima, et al. reported in 1980 that lithium cobaltate is useful as the cathode active material for lithium ion secondary batteries (Material Research Bulletin, vol. 15, pp. 783-789, 1980), lithium transition metal complex oxides have been intensively studied, and many proposals have been made.

Among lithium transition metal complex oxides preferred are LiCoO₂, LiNiO₂, and LiMn₂O₄; LiCoO₂ is particularly preferred and widely used from the viewpoint of safety and charge/discharge capacity.

In particular, lithium ion secondary batteries including a fluorine-containing lithium cobaltate prepared by adding fluorine to lithium cobaltate as a cathode active material are superior in discharge capacity and cycle characteristics. For example, Japanese Unexamined Patent Application Publication No. 2003-221235 discloses a lithium cobalt-based complex oxide containing 0.025% to 2.5% by weight of fluorine (F).

For producing a fluorine-containing lithium cobaltate, some methods have been proposed. For example, a fluorine compound gas is allowed to react with synthesized lithium cobaltate, or a fluorine compound is used as the raw material in a solid phase synthesis.

In a process for producing a fluorine-containing lithium cobaltate by firing a mixture of a lithium compound, a cobalt compound and a fluorine compound in a mullite firing container, however, the fired powder adheres to the contact wall of the firing container and cannot be taken out of the firing container undesirably.

Accordingly, Japanese Unexamined Patent Application Publication No. 2004-281163 discloses that a firing method using a firing container whose internal wall is covered with a dense ceramic coating containing less than 5% of silicon.

However, the performance required of recent lithium ion secondary batteries has become higher, and even the fluorine-containing lithium cobaltate disclosed in Japanese Unexamined Patent Application Publication No. 2003-221235 cannot provide lithium ion secondary batteries exhibiting satisfying performance, particularly sufficient cycling characteristics. The cycling characteristics mentioned herein refer to the maintenance ratios of capacity, discharge voltage, discharge energy, and so forth of the lithium ion secondary battery when it is repeatedly charged and discharged.

In the method disclosed in Japanese Unexamined Patent Application Publication No. 2004-281163, the ceramic coating highly increases the cost of the firing container. Also, ceramic coating is worn and removed from the firing container by repetitive use, and the fired powder adheres to the contact wall of the container eventually. Accordingly, the firing container is frequently replaced and this is not industrially advantageous.

### SUMMARY OF THE INVENTION

Accordingly, an object of the present invention is to provide a lithium transition metal complex oxide for a lithium ion secondary battery cathode active material, capable of achieving a high-performance lithium ion secondary battery, particularly exhibiting high cycling characteristics and a method for producing the same, the lithium ion secondary battery cathode active material, and the lithium ion secondary battery. Another object of the present invention is to provide an industrially advantageous method for producing the lithium transition metal complex oxide in which fired powder does not adhere to the firing container.

The present inventors have conducted intensive research to overcome the disadvantages of the known art, and have found that:

(1) by adding specific proportions of fluorine and silicon to a lithium transition metal complex oxide, the cycling characteristics of the lithium ion secondary battery can be increased, the safety of the battery can be prevented from being degraded by a gas generated, and the electrode material can be prevented from gelating during coating the electrode; and
(2) by further adding a silicon compound to the raw material mixture containing a lithium compound, a transition metal compound and a fluorine compound so that the content ratio of the fluorine compound to the silicon compound in the mixture is adjusted in a predetermined range, the raw material mixture can be subjected to be firing for producing a lithium transition metal complex oxide while the powder of the lithium transition metal complex oxide (hereinafter referred to as fired powder) is prevented from adhering to the firing container even if the firing container is made of mullite, the residual alkali content in the lithium transition metal complex oxide can be reduced, and the cycling characteristics of the resulting lithium ion secondary battery can be enhanced.

According to an aspect of the invention, a lithium transition metal complex oxide for a lithium ion secondary battery cathode active material is provided. The lithium transition metal complex oxide contains 100 to 1000 ppm of silicon and 300 to 900 ppm of fluorine.

According to another aspect of the invention, a method for producing a lithium transition metal complex oxide is provided. The method includes the steps of mixing a lithium compound, a transition metal compound, a fluorine compound, and a silicon compound to prepare a raw material mixture, and the step of firing the raw material mixture to produce the lithium transition metal complex oxide

According to still another aspect of the invention, a lithium ion secondary battery cathode active material containing the lithium transition metal complex oxide is provided.

According to a further aspect of the invention, a lithium ion secondary battery including the lithium ion secondary battery cathode active material is provided.

The invention provides a lithium transition metal complex oxide for a lithium ion secondary battery cathode active material, capable of achieving a high-performance lithium ion secondary battery, particularly exhibiting high cycling characteristics and a method for producing the same, the lithium ion secondary battery cathode active material, and the lithium ion secondary battery. Also, in the method for producing the lithium transition metal complex oxide, fired powder does not adhere to the firing container, and thus the method is industrially advantageous.

### DESCRIPTION OF THE PREFERRED EMBODIMENTS

The lithium transition metal complex oxide according to an embodiment of the invention is used as a cathode active material of a lithium ion secondary battery.

Cathode active materials of a lithium ion secondary battery include a principal active material repeating the charge/discharge of electrons and a secondary active material supplying electrons to the principal active material to prevent the principal active material from deteriorating in performance. The lithium transition metal complex oxide of the embodiment may be used as the principal active material or the secondary active material depending on the composition.

The lithium transition metal complex oxide of the present embodiment contains fluorine and silicon. The silicon content in the lithium transition metal complex oxide is in the range of 100 to 1000 ppm, and preferably in the range of 200 to 800 ppm. The fluorine content in the lithium transition metal complex oxide is in the range of 300 to 900 ppm, and preferably in the range of 400 to 800 ppm. When both the silicon content and the fluorine content in the lithium transition metal complex oxide are within these ranges, the crystal structure of the lithium transition metal complex oxide is stabilized by a synergistic effect between the silicon and the fluorine, and consequently the cycling characteristics of the lithium ion secondary battery is enhanced. On the other hand, a silicon content lower than the above-mentioned preferred range cannot sufficiently enhance the cycling characteristics, and a silicon content higher than that range causes a gas to be generated and thus degrades the safety, or causes the electrode material to seriously gelate during coating the electrode material. A fluorine content less than the above-mentioned preferred range in the lithium transition metal complex oxide does not lead to the effects of sufficiently preventing a gas from being generated from the silicon and the electrode material from gelating. A fluorine content higher than that range leads to a low conductivity and results in a low-performance battery.

A lithium transition metal complex oxide to which fluorine and silicon are to be added may contain:

(i) lithium and at least one transition metal element selected from the group consisting of cobalt, nickel, manganese, iron, vanadium, chromium, zirconium, copper, and titanium; or
(ii) lithium, a transition metal element selected from the group consisting of cobalt, nickel, manganese, iron, vanadium, chromium, zirconium, copper and titanium, and an element other than the transition metals.

For example, such lithium transition metal complex oxides include LiCoO₂, Liᵣ₁Ni_{(1-p1-q1)}Coₚ₁Mn_{q1}O₂ (where 0.4<r1<1.3, preferably 0.8≦r1≦1.2; 0<p1<1.0, preferably 0.05≦p1≦0.5; 0<q1<1.0, preferably 0.05≦q1≦0.5), LiFePO₄, Liᵣ₂Ni_{(1-p2-q2)}Coₚ₂Al_{q2}O₂ (where 0.4<r2<1.3, preferably 0.8≦r2 ≦1.2; 0<p2<1.0, preferably 0.05<p2<0.5; 0<q2<0.2, preferably 0.01≦q2≦0.1), LiNiₚ₃Mn₍₁₋ₚ₃₎O₄ (where 1.3≦p3≦1.7, preferably 1.4≦p3≦1.6), and LiMn₂O₄. Among these preferred is LiCoO₂ from the viewpoint of producing a lithium ion secondary battery exhibiting high cycling characteristics. Use of LiCoO₂ enhances the synergistic effect between fluorine and silicon, and thus can highly stabilize the crystal structure.

The lithium transition metal complex oxide of the embodiment may contain a trace amount (1% by weight or less) of another element, such as Mg or Al, to improve the safety and the charge/discharge characteristics of the lithium ion secondary battery.

The lithium transition metal complex oxide of the embodiment preferably has an average particle size in the range of 0.5 to 30.0 μm, and more preferably in the range of 5 to 25 μm. The lithium transition metal complex oxide having such a particle size enhances the safety of the resulting lithium ion secondary battery and can be packed at a high density.

The lithium transition metal complex oxide of the embodiment preferably has a BET specific surface area of 0.05 to 2.0 m²/g, more preferably 0.10 to 1.5 m²/g, and particularly 0.15 to 1.0 m²/g, from the viewpoint of enhancing the safety of the resulting lithium ion secondary battery.

The residual alkali content in the lithium transition metal complex oxide of the embodiment is preferably in the range of 0.005% to 0.15%, and particularly in the range of 0.01% to 0.1%. The residual alkali content mentioned herein refers to the amount in terms of Li₂CO₃ of the monovalent and divalent alkali components in the lithium transition metal complex oxide, obtained by acid-base titration. The lithium transition metal complex oxide having a residual alkali content in that range enhances the characteristics of the resulting battery, such as discharge capacity, and prevents the electrode material from gelating during coating the electrode material and a gas from being generated in the battery. However, a residual alkali content of less than that range in the lithium transition metal complex oxide is liable to lead to degrading the characteristics of the battery, such as discharge capacity. In contrast, a residual alkali content of more than that range is liable to cause the electrode material to gelate during coating and is liable to lead to generating a gas in the battery.

The method for producing the lithium transition metal complex oxide of the embodiment includes the steps of mixing a lithium compound, a transition metal compound, a fluorine compound and a silicon compound to prepare a raw material mixture, and then firing the raw material mixture to produce the lithium transition metal complex oxide.

In this method, a lithium compound and a transition metal compound, a fluorine compound, and a silicon compound are first mixed to prepare a raw material mixture.

The lithium compound is not particularly limited as long as it mainly contains lithium. Exemplary lithium compounds include lithium salts, lithium hydroxide (LiOH), lithium oxides, and organic lithium salts. Lithium salts include lithium carbonate (Li₂CO₃) and lithium nitrate (LiNO₃). Lithium oxides may be Li₂O. Organic lithium salts include lithium acetate (CH₃COOLi) and lithium alkoxides such as lithium ethoxide (C₂H₅OLi). Among these preferred is lithium carbonate because of its industrially low price. The lithium compound used in the method of the embodiment may be a combination of at least two lithium compounds. The physical properties of the lithium compound are not particularly limited, but preferably, the particle size is small from the viewpoint of uniform lithium distribution in the raw material mixture. Also, the average particle size of the lithium compound is preferably in the range of 0.1 to 200 μm, and more preferably in the range of 2 to 50 μm, from the viewpoint of increasing the reactivity.

Transition metal compounds used in the method of the embodiment include oxides, hydroxides, oxyhydroxides and salts of transition metals and contain at least one transition element selected from the group consisting of cobalt, nickel, manganese, iron, vanadium, chromium, zirconium, copper, and titanium. The transition metal salts include nitrates, carbonates and oxalates. The transition metal compound may be a complex compound containing at least two transition elements selected from the group consisting of cobalt, nickel, manganese, iron, vanadium, chromium, zirconium, copper and titanium, and examples of the complex compound include complex oxides, complex hydroxides, complex oxyhydroxides, complex nitrates, complex carbonate, and complex oxalates. Among these preferred are complex hydroxides, complex oxyhydroxides, complex carbonates, and complex oxides. The transition metal compound may be a combination of at least two transition metal compounds. The complex hydroxide can be prepared by, for example, coprecipitation. More specifically, a solution containing at least two of the above-listed transition elements and a solution of a complexing agent are mixed with an alkaline solution to coprecipitate a complex hydroxide (see Japanese Unexamined Patent Application Publication Nos. 10-81521, 10-81520, 10-29820, 2002-201028, etc.). For preparing a complex oxyhydroxide, a hydroxide prepared by the above-described coprecipitation may be oxidized by blowing air into the reaction liquid. The complex oxide can be prepared by heat-treating a hydroxide prepared by the above-described coprecipitation at a temperature of, for example, 200 to 500° C. For preparing a complex carbonate, a solution containing at least two transition elements and a solution of a complexing agent are mixed with a solution of alkali carbonate or alkali hydrogencarbonate as an alkali solution, as in the above-described coprecipitation. The physical properties of the transition metal compound are not particularly limited, but the particle size of the transition metal compound is preferably small from the viewpoint of uniform transition metal distribution in the raw material mixture. Also, the transition metal compound preferably has an average particle size in the range of 0.1 to 50 μm, and more preferably in the range of 2 to 25 μm from the viewpoint of increasing the reactivity.

The fluorine compound used in the method of the embodiment is not particularly limited as long as it mainly contains fluorine. For example, a fluoride may be used. Exemplary fluorides include LiF, CaF₂, MgF₂, CoF₂, and AlF₃. Among these preferred are LiF and MgF₂, from the viewpoint of increasing the reactivity with the transition metal complex oxide. The fluorine compound may be a combination of at least two fluorine compounds. The physical properties of the fluorine compound are not particularly limited, but the particle size is preferably small from the viewpoint of uniform fluorine distribution in the raw material mixture. Also, the fluorine compound preferably has an average particle size in the range of 0.1 to 100 μm and more preferably in the range of 5 to 50 μm, from the viewpoint of increasing the reactivity.

The silicon compound used in the method of the embodiment is not particularly limited as long as it mainly contains silicon. Exemplary silicon compounds include silicon oxides expressed by the formula SiOₓ (where 1≦x≦2, preferably 1.5≦x≦2), such as SiO₂, silicon compounds expressed by the formula M_{y}SiO_{z} (where M represents at least one element selected from the group consisting of Li, H, Co, Ni, Mn, Ti, Zr, Mg, and Al; 0≦y≦4, preferably 2≦y≦4; 2<Z≦4, preferably 3≦Z≦4), such as Li₂SiO₃, MgSiO₃, CoSiO₃, NiSiO₃, and MnSiO₃. Among these silicon compounds, preferred is SiO₂ because of its convenience and availability. The silicon compound used in the method of the embodiment may be a combination of at least two silicon compounds. The physical properties of the silicon compound are not particularly limited, but the particle size is preferably small from the viewpoint of uniform silicon distribution in the raw material mixture. Also, the silicon compound preferably has an average particle size in the range of 0.1 to 200 μm, and more preferably in the range of 5 to 50 μm, from the viewpoint of increasing the reactivity.

Although it does not matter when, where, or how the lithium compound, transition metal compound, fluorine compound and silicon compound used in the method of the embodiment are produced, impurities are removed from those compounds as much as possible from the viewpoint of producing a highly pure lithium transition metal complex oxide.

The lithium compound content in the raw material mixture is adjusted so that the molar ratio (Li/T) of the lithium (Li) of the lithium compound to the total transition metal atoms (T) of the transition metal compound is preferably in the range of 0.90 to 1.20, more preferably in the range of 0.98 to 1.15, and still preferably in the range of 1.00 to 1.10. The lithium compound content satisfying such a Li/T molar ratio advantageously leads to an increased discharge capacity, or leads to a difficulty in reducing the discharge capacity as well as leading to an increased discharge capacity. On the other hand, a Li/T molar ratio lower than the above ranges is liable to lead to a reduced discharge capacity, and a Li/T molar ratio higher than the above ranges is liable to lead to degraded cycling characteristics.

The fluorine compound content in the raw material mixture is adjusted so that the molar ratio (F/T) of the fluorine (F) of the fluorine compound to the total transition metal atoms (T) of the transition metal compound is preferably in the range of 0.0001 to 0.02, and particularly preferably in the range of 0.001 to 0.01. The fluorine compound content satisfying such a F/T molar ratio advantageously leads to high cycling characteristics.

The silicon compound content in the raw material mixture is adjusted so that the molar ratio (F/Si) of the fluorine (F) of the fluorine compound in the raw material mixture to the total silicon (Si) in the raw material mixture is in the range of 0.5 to 20, and preferably in the range of 1 to 10. An F/Si molar ratio in these ranges leads to enhanced cycling characteristics, and prevents the fired powder from adhering to the firing container. Since the transition metal compound may contain silicon, the total silicon content on the molar basis in the raw material mixture is the sum of the moles of the silicon of the silicon compound and the silicon in the transition metal compound.

The lithium compound, the transition metal compound, the fluorine compound and the silicon compound are mixed by, but not limited to, dry blending or wet blending. Preferably, dry blending is applied because of its simple process. For dry blending, a blender capable of uniformly blending the raw materials is preferably used.

The resulting raw material mixture is fired to produce the lithium transition metal complex oxide. For firing, the raw material mixture is placed in a firing container. The material of the firing container is not particularly limited as long as it is not cracked or degraded in strength by heating or cooling in the step of firing. For example, the firing container may be made of mullite, cordierite, or mullite or cordierite coated with spinel, magnesia, alumina, silicon carbide or zirconia. Among these preferred are mullite and cordierite because of their high mechanical strength and high resistance to thermal shock. The method of the embodiment can prevent the fired powder from adhering to the mullite or cordierite firing container effectively.

In the method of the embodiment, firing container is placed in a firing furnace capable of uniformly heating the raw material mixture. The firing furnace may be a batch-type or a continuous type without particular limitation. Preferably, a continuous firing furnace is used because of its high productivity. The continuous firing furnace may be, for example, a pressure heating furnace or a roller hearth kiln.

The firing conditions for firing the raw material mixture are not particularly limited and are appropriately set depending on the types of lithium compound, transition metal compound, fluorine compound and silicon compound. For use of a raw material mixture containing a compound that can generate moisture during firing, such as a hydroxide, an oxyhydroxide, or a hydrate salt, multistage firing is preferably performed. In this instance, preferably, water is removed by firing at a temperature in the range of about 200 to 400° C. for 1 to 5 hours (pre-firing), and then main firing is performed at a temperature in the range of 600 to 1150° C. for 1 to 30 hours. An additional firing (post-firing) may further be performed at a temperature of 500 to 700° C. for 1 to 10 hours after the main firing in order to for example, reduce oxygen defects in the lithium transition metal complex oxide.

The firing of the raw material mixture is performed in an oxidizing atmosphere, and preferably in the air from the viewpoint of the ease of controlling the atmosphere. If multistage firing is performed, at least the main firing is performed in an oxidizing atmosphere, and the atmosphere of the pre-firing is not particularly limited.

After firing the raw material mixture, followed by cooling, the fired material is pulverized and classified if necessary, thus producing the lithium transition metal complex oxide. The pulverization and classification are performed if the fired material is in a loosely combined brittle block.

The lithium transition metal complex oxide obtained by the method of the embodiment preferably has an average particle size of 0.5 to 30.0 μm, particularly 5 to 25 μm, and a BET specific surface area of 0.05 to 2.0 m²/g, more preferably 0.10 to 1.5 m²/g, and particularly 0.15 to 1.0 m²/g.

The feature of the method of the embodiment is that a silicon compound is mixed with a mixture containing a lithium compound, a transition metal compound and a fluorine compound in a specific proportion. The thus prepared raw material mixture containing the silicon compound is fired. Consequently, the following effects are produced:

(i) The fired powder is prevented from adhering to the firing container during firing, and accordingly a lithium transition metal complex oxide can be industrially advantageously produced.
(ii) Lithium ion secondary batteries using the resulting lithium transition metal complex oxide can exhibit high cycling characteristics.

The adhesion of the fired powder means that the fired powder reacts with the firing container to adhere tightly to the firing container, and refers to a state in which a block of the fired powder does not fall off under its own weight even if the firing container is inverted, or a state in which even if the fired powder block falls off under its own weight, the fired powder is removed from the firing container together with part of the firing container peeled off. The adhesion may be in a state in which the fired powder block adheres tightly to the entire contact surface of the firing container or part of the contact surface.

The reason why the addition of a silicon compound to the raw material mixture prevents the fired powder from adhering to the firing container is not clear. However, it is believed that the fluorine component and the silicon component in the raw material mixture preferentially react with each other and consequently inhibit the reaction between the fluorine component in the raw material mixture and the silicon component in the mullite firing container, thus inhibiting the reaction between the fired powder and the firing container.

The lithium ion secondary battery cathode active material according to an embodiment of the invention contains the lithium transition metal complex oxide of the embodiment.

The lithium ion secondary battery cathode active material of the embodiment is as follows:

(a) When the lithium ion secondary battery cathode active material of the embodiment does not contain a secondary active material, the principal active material of the lithium ion secondary battery cathode active material contains the lithium transition metal complex oxide according to an embodiment of the present invention.
(b) When the lithium ion secondary battery cathode active material is constituted of a principal active material and a secondary active material, (i) the principal active material of the lithium ion secondary battery cathode active material contains the lithium transition metal complex oxide according to an embodiment of the present invention; (ii) the secondary active material contains the lithium transition metal complex oxide according to an embodiment of the present invention; or (iii) both the principal active material and the secondary active material contain the lithium transition metal complex oxide according to an embodiment of the present invention.

The lithium ion secondary battery according to an embodiment of the present invention uses the lithium ion secondary battery cathode active material according to an embodiment of the invention and contains a cathode, an anode, a separator, and a nonaqueous electrolyte containing a lithium salt.

The cathode of the lithium ion secondary battery of the embodiment is prepared by, for example, evenly applying a cathode mixture onto a cathode charge collector, followed by drying. The cathode mixture contains the lithium ion secondary battery cathode active material according to an embodiment of the invention, a conducting agent and a binder, and optionally filler. The cathode is evenly coated with the lithium transition metal complex oxide. Thus, the lithium ion secondary battery exhibits high load characteristics (particularly initial discharge capacity and initial discharge voltage) and high cycling characteristics.

The cathode active material content in the cathode mixture is in the range of 70% to 98% by mass, and preferably in the range of 90% to 95% by mass.

Any electron-conducting material can be used as the conducting agent without particular limitation as long as the battery using the conducting agent will not chemically change. Examples of the conducting agent include: graphite, such as natural graphite and artificial graphite; carbon black materials, such as carbon black, acetylene black, Ketjen Black, channel black, furnace black, lampblack, and thermal black; conductive fibers, such as carbon fiber and metal fiber; carbon fluoride; metal powders, such as aluminum powder and nickel powder; conductive whiskers, such as zinc oxide and potassium titanate; conductive metal oxides, such as titanium oxide; and other conductive materials such as polyphenylene derivatives. Natural graphite may vein graphite, flake graphite, or amorphous graphite. These conducting agents may be used singly or in combination. The conducting agent content in the cathode mixture is in the range of 1% to 50% by mass, and preferably in the range of 2% to 30% by mass.

Examples of the binder include starch, polyvinylidene fluoride, polyvinyl alcohol, carboxymethyl cellulose, hydroxypropyl cellulose, recycled cellulose, diacetyl cellulose, polyvinylpyrrolidone, tetrafluoroethylene, polyethylene, polypropylene, ethylene-propylene-dieneter polymer (EPDM), sulfonated EPDM, styrene butadiene rubber, fluorine rubber, tetrafluoroethylene-hexafluoroethylene copolymer, tetrafluoroethylene-hexafluoropropylene copolymer, tetrafluoroethylene-perfluoroalkyl vinyl ether copolymer, vinylidene fluoride-hexafluoropropylene copolymer, vinylidene fluoride-chlorotrifluoroethylene copolymer, ethylene-tetrafluoroethylene copolymer, polychlorotrifluoroethylene, vinylidene fluoride-pentafluoropropylene copolymer, propylene-tetrafluoroethylene copolymer, ethylene-chlorotrifluoroethylene copolymer, vinylidene fluoride-hexafluoropropylene-tetrafluoroethylene copolymer, vinylidene fluoride-perfluoromethyl vinyl ether-tetrafluoroethylene copolymer, ethylene-acrylic acid copolymer and its sodium ion-cross-linked polymer, ethylene-methacrylic acid copolymer and its sodium ion-cross-linked polymer, ethylene-methyl acrylate copolymer and its sodium ion-cross-linked polymer, ethylene-methyl methacrylate copolymer and its sodium ion-cross-linked polymer, polysaccharides such as polyethylene oxide, thermoplastic resins, and rubber-elastic polymers. These binders may be used singly or in combination. If a compound having a functional group capable of reacting with lithium, such as polysaccharides, is used as the binder, the functional group is preferably deactivated by adding, for example, an isocyanate group. The binder content in the cathode mixture is in the range of 1% to 50% by mass, and preferably in the range of 5% to 15% by mass.

The filler is intended to suppress the volume expansion of the cathode, and is added to the cathode mixture as required. Any fiber can be used as the filler as long as it does not chemically change in the battery. Examples of the filler include olefin polymer fibers, such as polypropylene fiber and polyethylene fiber, and glass and carbon fibers. The filler content in the cathode mixture is preferably, but not limited to, 0% to 30% by mass.

The cathode charge collector can be made of any electron conducting material, as long as the material does not chemically change in the battery. Exemplary materials of the cathode charge collector include stainless steel, nickel, aluminum, titanium, fired carbon, and aluminum or stainless steel surface-treaded with carbon, nickel, titanium, or silver. These materials may be surface-treated by oxidation, or have asperities at the surface formed by surface treatment. The cathode charge collector may be in a form of foil, film, sheet, net, punched sheet, lath body, porous body, foamed body, fiber, or formed nonwoven fabric. The thickness of the cathode charge collector is preferably, but not limited to, 1 to 500 μm.

The anode is formed by applying an anode material onto an anode charge collector, followed by drying. The anode charge collector can be made of any electron conducting material, as long as the material does not chemically change in the battery. Exemplary materials of the anode charge collector include stainless steel, nickel, copper, titanium, aluminum, fired carbon, steel or stainless steel surface-treated with carbon, nickel, titanium, or silver, and aluminum-cadmium alloys. These materials may be surface-treated by oxidation, or have asperities at the surface formed by surface treatment. The anode charge collector may be in a form of foil, film, sheet, net, punched sheet, lath body, porous body, foamed body, fiber, or formed nonwoven fabric. The thickness of the anode charge collector is preferably, but not limited to, 1 to 500 μm.

Examples of the anode material include, but not limited to, carbonaceous materials, metal complex oxides, lithium metal, lithium alloys, silicon alloys, tin alloys, metal oxides, conductive polymers, chalcogenides, and Li—Co—Ni materials. Carbonaceous materials used as the anode material include, for example, non-graphitizable carbon materials and graphitic carbon materials. Metal complex oxides used as the anode material may be expressed by the formulas: Snₐ(A¹)₍₁₋ₐ₎(A²)_{b}O_{c} (where A¹ represents at least one element selected from the group consisting of Mn, Fe, Pb, and Ge, A² represents at least one element selected from the group consisting of A¹, B, P, Si, Group I elements, Group II elements, Group III elements, and halogen elements, 0<a≦1, 1≦b≦3, 1≦C≦B); Li_{d}Fe₂O₃ (where 0≦d≦1); and LiₑWO₂ (where 0≦e≦1). Metal oxides used as the anode material include GeO, GeO₂, SnO, SnO₂, PbO, PbO₂, Pb₂O₃, Pb₃O₄, Sb₂O₃, Sb₂O₄, Sb₂O₅, Bi₂O₃, Bi₂O₄, and Bi₂O₅. Conductive polymers used as the anode material include polyacetylene and poly-p-phenylene.

The separator is made of an insulating thin film having a high ion permeability and a specific mechanical strength. Form the viewpoint of resistance to organic solvents and hydrophobicity, a sheet or nonwoven fabric made of an olefin polymer such as polypropylene, glass fiber, or polyethylene is used as the separator. The separator has pores having a size generally useful for batteries, and the pore size is for example, 0.01 to 10 μm. The thickness of the separator can be in a range generally used for batteries, and may be, for example, 5 to 300 μm. If a solid electrolyte made of, for example, a polymer is used as the below-described electrolyte, the solid electrolyte may double as the separator.

The lithium salt-containing nonaqueous electrolyte is constituted of a nonaqueous electrolyte and a lithium salt. The nonaqueous electrolyte may be a liquid, an organic solid, or an inorganic solid. The nonaqueous liquid electrolyte may be an aprotic organic solvent or a mixture of aprotic organic solvents. Exemplary aprotic organic solvents include N-methyl-2-pyrrolidinone, propylene carbonate, ethylene carbonate, butylene carbonate, dimethyl carbonate, diethyl carbonate, γ-butyrolactone, 1,2-dimethoxyethane, tetrahydroxyfuran, 2-methyltetrahydrofuran, dimethylsulfoxide, 1,3-dioxolane, formamide, dimethylformamide, dioxolane, acetonitrile, nitromethane, methyl formate, methyl acetate, phosphotriester, trimethoxymethane, dioxolane derivatives, sulfolane, methylsulfolane, 3-methyl-2-oxazolidinone, 1,3-dimethyl-2-imidazolidinone, propylene carbonate derivatives, tetrahydrofuran derivatives, diethyl ether, 1,3-propane sultone, methyl propionate, and ethyl propionate.

Exemplary organic solid electrolytes include polyethylene derivatives, polyethylene oxide derivatives and polymers containing a polyethylene oxide derivative, polypropylene oxide derivatives and polymers containing a polypropylene oxide derivative, phosphate polymers, polymers containing an ionic leaving group, such as polyphosphazenes, polyaziridines, polyethylene sulfide, polyvinyl alcohol, polyvinylidene fluoride, and polyhexafluoropropylene, and a mixture of a polymer containing an ionic leaving group and an above-described nonaqueous electrolyte.

The inorganic solid electrolyte may be a nitride, halide, oxoate or sulfide of lithium. Exemplary inorganic solid electrolytes include Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, P₂S₅, Li₂S, Li₂S—P₂S₅, Li₂S—SiS₂, Li₂S—GeS₂, Li₂S—Ga₂S₃, Li₂S—B₂S₃, Li₂S—P₂S₅—X, Li₂S—SiS₂—X, Li₂S—GeS₂—X, Li₂S—Ga₂S₃—X, and Li₂S—B₂S₃—X (where X represents at least one compound selected from the group consisting of LiI, B₂S₃, and Al₂S₃).

If the inorganic solid electrolyte is amorphous (vitreous), the inorganic solid electrolyte may contain a compound containing oxygen, such as lithium phosphate (Li₃PO₄), lithium oxide (Li₂O), lithium sulfate (Li₂SO₄), phosphorus oxide (P₂O₅), or lithium borate (Li₃BO₃); or compound containing nitrogen, such as Li₃PO_{(4-f)}N_{(2f/3)} (where 0<f<4), Li₄SiO_{(4-g)}N_{(2g/3)} (where 0<g<4), Li₄GeO₍₄₋ₕ₎N_{(2h/3)} (where 0<h<4), or Li₃BO₍₃₋ᵢ₎N_{(2i/3)} (where 0<i<3). By adding an oxygen-containing compound or a nitrogen-containing compound, lithium ions (Li+) are allowed to hop the unshared electron pair of the oxygen or nitrogen atom and, thus, the lithium ion conductivity can be enhanced.

The lithium salt used in the lithium salt-containing nonaqueous electrolyte is soluble in the nonaqueous electrolyte. Exemplary such lithium salts include LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃L₁, CF₃SO₃Li, (CF₃SO₂)₂NLi, (C₂O₄)₂BLi, chloroborane lithium, lithium lower aliphatic carboxylates, lithium tetraphenylborate, and lithium imides. These lithium salts may be use singly or in combination.

The nonaqueous electrolyte may contain another compound to enhance the charge/discharge characteristics and the flame retardancy: Examples of such compounds include pyridine, triethylphosphite, triethanolamine, cyclic ethers, ethylenediamine, n-glyme, hexaphosphoric triamide, nitrobenzene derivatives, sulfur, quinonimine dyes, N-substituted oxazolidinone, N,N-substituted imidazolidine, ethylene glycol dialkyl ethers, ammonium salts, polyethylene glycol, pyrrole, 2-methoxyethanol, aluminum trichloride, monomers of electroconductive polymer electrode active materials, triethylenephosphonamide, trialkylphosphine, morpholine, aryl compounds having a carbonyl group, hexamethylphosphoric triamide, 4-alkylmorpholin, bicycle tertiary amine, oil, phosphonium salts, tertiary sulfonium salts, phosphazene, and carbonic esters. The nonaqueous electrolyte liquid may contain a halogen-containing solvent, such as carbon tetrachloride or ethylene trifluoride, to make the electrolyte noncombustible. The nonaqueous electrolyte liquid may contain carbonic acid gas so as to be storable at high temperatures.

The lithium ion secondary battery of an embodiment of the invention exhibits high performance, particularly high cycling characteristics, and may be in any form, including button, sheet, cylinder, prism, and coin.

The lithium ion secondary battery can be used in any devices and apparatuses, including automobiles, electromotive vehicles, game machines and other consumer appliances, such as electronic notebook personal computers, laptop personal computers, pocket word processors, cellular phones, cordless slaves, portable CD players, radios, liquid crystal TV sets, backup power sources, electric shavers, memory cards, and video movie cameras/recorders/players.

The present invention will be further described with reference to Examples, but the invention is not limited to the Examples.

### EXAMPLES

### Measuring Average Particle Size

The average particle size was measured with a particle size distribution meter, Microtrac HRA (X-100) manufactured by Nikkiso.

Measuring Silicon Content:

Lithium cobaltate was dissolved in perchloric acid with heating, and the silicon content in the solution was measured with an inductively coupled plasma (ICP) analyzer, Liberty II manufactured by Varian.

Measuring Fluorine Content:

In 0.5 g of lithium cobaltate was added 100 g of pure water. The mixture was sufficiently stirred at 25° C. to elute fluorine to the water from the lithium cobaltate, and the fluorine content in the solution was measured by ion chromatography.

Measuring Residual Alkali Content:

In a 100 mL beaker were placed 10 g of lithium cobaltate 10 g and 50 g of pure water and stirred for 5 minutes. Then, the supernatant liquor was filtered to collect filtrate A. To the filter cake was added 50 g of pure water again and stirred for 5 minutes. The supernatant liquor was filtered again to collect filtrate B. Filtrates A and B were mixed, and 60 g of the mixture was weighed out and titrated with 0.1 N HCl solution. The alkali content was calculated from the amount of the HCl solution used for the titration, and the residual alkali content was calculated in terms of Li₂CO₃ from the alkali content.

### Example 1

Commercially available lithium carbonate (produced by SQM, average particle size: 7 μm), commercially available cobalt oxide (CO₃O₄, produced by OMG, average particle size: 5 μm), commercially available magnesium fluoride (MgF₂, produced by Stella Chemifa, average particle size: 6 μm), and commercially available silicon oxide (SiO₂, produced by Junsei Chemical, average particle size: 17 μm) were weighed out according to Table 1 and sufficiently mixed in a mortar to prepare a homogeneous raw material mixture. Then, the raw material mixture placed in a round mullite sagger (R2013, manufactured by Toshiba Ceramics, inner diameter: 13 cm) was placed in an electrically heated furnace. The raw material mixture was heated in an atmosphere of air and allowed to stand at 1020° C. for 5 hours to be fired. After cooling the resulting fired powder block in the sagger in the air, the sagger was inverted to check whether or not the fired powder adhered to the sagger or firing container. The fired powder block fell out of the sagger without peeling the sagger, thus showing that the fired powder did not adhere to the sagger. The resulting fired powder block was pulverized and classified to prepare a lithium cobaltate powder. The lithium cobaltate powder was measured for the average particle size, the BET specific surface area, the silicon content, the fluorine content, and the residual alkali content. The results are shown in Table 2. The same lithium cobaltate was used for battery performance tests. In addition, the lithium cobaltate was fired in the same mullite sagger twenty times under the above conditions, but adhesion did not occur.

### Examples 2 to 4

Homogeneous raw material mixtures were prepared in the same manner as in Example 1, except that the amounts of the raw materials shown in Table 1 were mixed. Then, each raw material mixture in a round mullite sagger (R2013, manufactured by Toshiba Ceramics, inner diameter: 13 cm) was placed in an electrically heated furnace. The raw material mixture was heated in an atmosphere of air and allowed to stand at 1020° C. for 5 hours to be fired. After cooling the resulting fired powder block in the sagger in the air, the sagger was inverted to check whether or not the fired powder adhered to the sagger or firing container. Any fired powder block fell out of the sagger without peeling the sagger, thus showing that the fired powder did not adhere to the sagger. The resulting fired powder blocks were pulverized and classified to prepare lithium cobaltate powders. The lithium cobaltate powders were each measured for the average particle size, the BET specific surface area, the silicon content, the fluorine content, and the residual alkali content. The results are shown in Table 2. The same lithium cobaltate was used for battery performance tests. In addition, the lithium cobaltate was fired in the same mullite sagger twenty times in the same manner as in Example 1, but no lithium cobaltate adhered to the sagger.

### Comparative Example 1

A homogeneous raw material mixture was prepared in the same manner as in Example 1, except that the amounts of the raw materials shown in Table 1 were mixed. Then, the raw material mixture in a round mullite sagger (R2013, manufactured by Toshiba Ceramics, inner diameter: 13 cm) was placed in an electrically heated furnace. The raw material mixture was heated in an atmosphere of air and allowed to stand at 1020° C. for 5 hours to be fired. After cooling the resulting fired powder block in the sagger in the air, the sagger was inverted to check whether or not the fired powder adhered to the sagger or firing container. The fired powder block did not fall down, thus showing that the fired powder adhered to the sagger. The fired powder block was collected avoiding contamination with sagger constituents, and was pulverized and classified to prepare a lithium cobaltate powder. The lithium cobaltate powder was measured for the average particle size, the BET specific surface area, the silicon content, the fluorine content, and the residual alkali content. The results are shown in Table 2.

### Comparative Example 2

A homogeneous raw material mixture was prepared in the same manner as in Example 1, except that the amounts of the raw materials shown in Table 1 were mixed. Then, the raw material mixture in a round mullite sagger (R2013, manufactured by Toshiba Ceramics, inner diameter: 13 cm) was placed in an electrically heated furnace. The raw material mixture was heated in an atmosphere of air and allowed to stand at 1020° C. for 5 hours to be fired. After cooling the resulting fired powder block in the sagger in the air, the sagger was inverted to check whether or not the fired powder adhered to the sagger or firing container. Any fired powder block fell out of the sagger without peeling the sagger, thus showing that the fired powder did not adhere to the sagger. The resulting fired powder block was pulverized and classified to prepare a lithium cobaltate powder. The lithium cobaltate powder was measured for the average particle size, the BET specific surface area, the silicon content, the fluorine content, and the residual alkali content. The results are shown in Table 2.

### Comparative Example 3

A homogeneous raw material mixture was prepared in the same manner as in Example 1, except that the amounts of the raw materials shown in Table 1 were mixed. Then, the raw material mixture in a round mullite sagger (R2013, manufactured by Toshiba Ceramics, inner diameter: 13 cm) was placed in an electrically heated furnace. The raw material mixture was heated in an atmosphere of air and allowed to stand at 1020° C. for 5 hours to be fired. After cooling the resulting fired powder block in the sagger in the air, the sagger was inverted to check whether or not the fired powder adhered to the sagger or firing container. The fired powder block fell out of the sagger without peeling the sagger, thus showing that the fired powder did not adhere to the sagger. The resulting fired powder block was pulverized and classified to prepare a lithium cobaltate powder. The lithium cobaltate powder was measured for the average particle size, the BET specific surface area, the silicon content, the fluorine content, and the residual alkali content. The results are shown in table 2.

### Comparative Example 4

A homogeneous raw material mixture was prepared in the same manner as in Example 1, except that the amounts of the raw materials shown in Table 1 were mixed. Then, the raw material mixture in a round mullite sagger (R2013, manufactured by Toshiba Ceramics, inner diameter: 13 cm) was placed in an electrically heated furnace. The raw material mixture was heated in an atmosphere of air and allowed to stand at 1020° C. for 5 hours to be fired. After cooling the resulting fired powder block in the sagger in the air, the sagger was inverted to check whether or not the fired powder adhered to the sagger or firing container. The fired powder block did not fall down, thus showing that the fired powder adhered to the sagger. The fired powder block was collected avoiding contamination with sagger constituents, and was pulverized and classified to prepare a lithium cobaltate powder. The lithium cobaltate powder was measured for the average particle size, the BET specific surface area, the silicon content, the fluorine content, and the residual alkali content. The results are shown in Table 2.

### Comparative Example 5

A homogeneous raw material mixture was prepared in the same manner as in Example 1, except that the amounts of the raw materials shown in Table 1 were mixed. Then, the raw material mixture in a round mullite sagger (R2013, manufactured by Toshiba Ceramics, inner diameter: 13 cm) was placed in an electrically heated furnace. The raw material mixture was heated in an atmosphere of air and allowed to stand at 1020° C. for 5 hours to be fired. After cooling the resulting fired powder block in the sagger in the air, the sagger was inverted to check whether or not the fired powder adhered to the sagger or firing container. The fired powder block did not fall down, thus showing that the fired powder adhered to the sagger. The fired powder block was collected avoiding contamination with sagger constituents, and was pulverized and classified to prepare a lithium cobaltate powder. The lithium cobaltate powder was measured for the average particle size, the BET specific surface area, the silicon content, the fluorine content, and the residual alkali content. The results are shown in Table 2.

### Comparative Example 6

A homogeneous raw material mixture was prepared in the same manner as in Example 1, except that the amounts of the raw materials shown in Table 1 were mixed. Then, the raw material mixture in a round mullite sagger (R2013, manufactured by Toshiba Ceramics, inner diameter: 13 cm) was placed in an electrically heated furnace. The raw material mixture was heated in an atmosphere of air and allowed to stand at 1020° C. for 5 hours to be fired. After cooling the resulting fired powder block in the sagger in the air, the sagger was inverted to check whether or not the fired powder adhered to the sagger or firing container. The fired powder block fell out of the sagger without peeling the sagger, thus showing that the fired powder did not adhere to the sagger. The resulting fired powder block was pulverized and classified to prepare a lithium cobaltate powder. The lithium cobaltate powder was measured for the average particle size, the BET specific surface area, the silicon content, the fluorine content, and the residual alkali content. The results are shown in Table 2.

TABLE 1

| | Li2CO3(g) | Co3O4(g) | Li/Co | MgF2(g) | F/Co | SiO2(g) | F/Si |
|---|---|---|---|---|---|---|---|
| Example 1 | 95.16 | 204.0 | 1.1015 | 0.87 | 0.01 | 0.21 | 8.0 |
| Example 2 | 95.16 | 204.0 | 1.1015 | 0.87 | 0.01 | 0.42 | 4.0 |
| Example 3 | 95.16 | 204.0 | 1.1015 | 0.87 | 0.01 | 0.84 | 2.0 |
| Example 4 | 95.16 | 204.0 | 1.1015 | 0.44 | 0.005 | 0.21 | 4.0 |
| Comparative Example 1 | 95.16 | 204.0 | 1.1015 | 0.87 | 0.01 | 0 | — |
| Comparative Example 2 | 95.16 | 204.0 | 1.1015 | 0 | — | 0.21 | — |
| Comparative Example 3 | 95.16 | 204.0 | 1.1015 | 0.87 | 0.01 | 8.4 | 0.2 |
| Comparative Example 4 | 95.16 | 204.0 | 1.1015 | 0.87 | 0.01 | 0.06 | 28.0 |
| Comparative Example 5 | 95.16 | 204.0 | 1.1015 | 2.61 | 0.03 | 0.21 | 24.0 |
| Comparative Example 6 | 95.16 | 204.0 | 1.1015 | 0.26 | 0.003 | 1.68 | 0.3 |

TABLE 2

| | Average | BET | F | Si | |
|---|---|---|---|---|---|
| | particle | spe- | content | content | Residual |
| | size | cific | (ppm) | (ppm) | alkali |
| Example 1 | 7.2 | 0.41 | 720 | 190 | 0.032 |
| Example 2 | 7.2 | 0.42 | 670 | 530 | 0.043 |
| Example 3 | 7.4 | 0.40 | 480 | 857 | 0.041 |
| Example 4 | 7.1 | 0.40 | 360 | 152 | 0.021 |
| Comparative Example 1 | 6.7 | 0.45 | 980 | 26 | 0.029 |
| Comparative Example 2 | 7.5 | 0.38 | 31 | 390 | 0.165 |
| Comparative Example 3 | 8.0 | 0.36 | 250 | 15000 | 0.241 |
| Comparative Example 4 | 6.5 | 0.52 | 320 | 78 | 0.009 |
| Comparative Example 5 | 5.7 | 0.60 | 1250 | 172 | 0.004 |
| Comparative Example 6 | 8.1 | 0.36 | 256 | 2850 | 0.091 |

### Examples 5 to 8

### Comparative Examples 7 to 12

### Battery Performance Tests

### (1) Preparing Lithium Secondary Batteries

Mixed were 91% by mass of lithium cobaltate prepared in any one of Examples 1 to 4 and Comparative Examples 1 to 6, 6% by mass of graphite powder, and 3% by mass of polyvinylidene fluoride to prepare a cathode material. The cathode material was dispersed in N-methyl-2-pyrrolidinone to prepare a mixed paste. Aluminum foil was coated with the mixed paste, followed by drying. Then, the aluminum foil was stamped into a disk of 15 mm in diameter used as a cathode plate.

Lithium secondary batteries, each including a separator, an anode, a cathode, a charge collector, an attachment, an external terminal, an electrolyte, and other members, were produced using the cathode plate. The anode was made of metallic lithium foil, and the electrolyte was prepared by dissolving 1 mol of LiPF₆ in 1 L of a mixture containing ethylene carbonate and ethylmethyl carbonate in a ratio of 1:1.

### (2) Evaluating Battery Performance

The lithium secondary batteries thus produced were operated at room temperature and under the following conditions for evaluating the performance.

Evaluating Cycling Characteristics

The cathode was subjected to constant current/constant voltage (CC/CV) charge to 4.3 V at 1.0 C over a period of 5 hours, and was then discharged to 2.7 V at a discharge rate of 0.2 C. A sequence of this charge/discharge procedure is defined as one cycle. The discharge capacity (unit: mAH/g) and the electric energy (unit: mWH/g) were measured for each cycle. The charge/discharge sequence was repeated 20 cycles, and the discharge capacity maintenance ratio and the electric energy maintenance ratio were calculated from the following equations using the discharge capacities and electric energies at the first cycle and the 20th cycle:

Discharge capacity maintenance ratio (%)=(discharge capacity at the 20th cycle)/(discharge capacity at the first cycle)×100

Electric energy maintenance ratio (%)=(electric energy at the 20th cycle)/(electric energy at the first cycle)×100

The discharge capacity at the first cycle is designated as initial discharge capacity, and the electric energy at the first cycle is designated as initial electric energy.

TABLE 3

| | | Initial | Initial | Average | Discharge capacity | Electric energy |
|---|---|---|---|---|---|---|
| | | discharge | electric | discharge | maintenance | maintenance |
| | Cathode active material | capacity (mAH/g) | energy (mWH/g) | voltage (V) | ratio | ratio |
| Example 5 | Example 1 | 161.6 | 620.5 | 3.96 | 97.1 | 96.9 |
| Example 6 | Example 2 | 161.5 | 620.4 | 3.96 | 97.3 | 97.1 |
| Example 7 | Example 3 | 161.0 | 619.8 | 3.95 | 97.4 | 97.5 |
| Example 8 | Example 4 | 161.3 | 620.0 | 3.95 | 97.2 | 97.6 |
| Comparative Example 7 | Comparative Example 1 | 1613 | 620.8 | 3.95 | 96.1 | 91.3 |
| Comparative Example 8 | Comparative Example 2 | 161.1 | 619.6 | 3.96 | 88.5 | 82.1 |
| Comparative Example 9 | Comparative Example 3 | 157.2 | 615.1 | 3.96 | 85.2 | 81.3 |
| Comparative Example 10 | Comparative Example 4 | 154.3 | 613.3 | 3.93 | 96.3 | 90.4 |
| Comparative Example 11 | Comparative Example 5 | 155.2 | 613.0 | 3.91 | 96.1 | 90.3 |
| Comparative Example 12 | Comparative Example 6 | 158.5 | 615.7 | 3.92 | 89.5 | 80.9 |

Cathode active material; Initial discharge capacity (mAH/g); Initial electric energy (mWH/g); Average discharge voltage (V), Discharge capacity maintenance ratio (%); Electric energy maintenance ratio (%)

### Example 1

### Comparative Example 1

Tables 2 and 3 show that the lithium cobaltates prepared in Examples 1 to 4 exhibited high initial discharge capacities and high cycling characteristics without adhering to the firing container, and that the lithium cobaltates prepared in Comparative Examples 1 to 6 could not exhibit satisfying cycling characteristics. In addition, the lithium cobaltates of Comparative Examples 1, 4, and 5 adhered to the firing container.

This application is based on Japanese Patent Application Nos. 2007-094190 filed on Mar. 30, 2007 and 2008-059244 filed on Mar. 10, 2008, the contents of which are incorporated hereinto by reference

What is claimed is:

1. A lithium transition metal complex oxide for a lithium ion secondary battery cathode active material, containing 100 to 1000 ppm of silicon and 300 to 900 ppm of fluorine.

2. A method for producing a lithium transition metal complex oxide, comprising the steps of:
mixing a lithium compound, a transition metal compound, a fluorine compound, and a silicon compound to prepare a raw material mixture; and
firing the raw material mixture, thereby producing the lithium transition metal complex oxide.

3. The method according to claim 2, wherein the fluorine compound is at least one compound selected from the group consisting of LiF, CaF₂, MgF₂, CoF₂, and AlF₃.

4. The method according to claim 2, wherein the silicon compound is at least one of the compounds expressed by SiOₓ and M_{y}SiO_{z}, wherein x represents a number satisfying 1≦x≦2, M represents at least one element selected from the group consisting of Li, H, Co, Ni, Mn, Mg, and Al, y represents a number satisfying 0≦y≦4, and z represents a number satisfying 2<z≦4.

5. The method according to claim 3, wherein the silicon compound is at least one of the compounds expressed by SiOₓ and M_{y}SiO_{z}, wherein x represents a number satisfying 1≦x≦2, M represents at least one element selected from the group consisting of Li, H, Co, Ni, Mn, Mg, and Al, y represents a number satisfying 0<y≦4, and z represents a number satisfying 2<z≦4.

6. The method according to claim 2, wherein the molar ration (F/Si) of the fluorine of the fluorine compound to the silicon of the raw material mixture, in the raw material mixture is in the range of 0.5 to 20.

7. The method according to claim 3, wherein the molar ration (F/Si) of the fluorine of the fluorine compound to the silicon of the raw material mixture, in the raw material mixture is in the range of 0.5 to 20.

8. The method according to claim 4, wherein the molar ration (F/Si) of the fluorine of the fluorine compound to the silicon of the raw material mixture, in the raw material mixture is in the range of 0.5 to 20.

9. The method according to claim 5, wherein the molar ration (F/Si) of the fluorine of the fluorine compound to the silicon of the raw material mixture, in the raw material mixture is in the range of 0.5 to 20.

10. A lithium ion secondary battery cathode active material containing a lithium transition metal complex oxide containing 100 to 1000 ppm of silicon and 300 to 900 ppm of fluorine.

11. A lithium ion secondary battery comprising an anode and a cathode, wherein the cathode includes a lithium ion secondary battery cathode active material containing a lithium transition metal complex oxide containing 100 to 1000 ppm of silicon and 300 to 900 ppm of fluorine.
